(19) United States
(12) Patent Application Publication
(10) Pub. No.: US 2007/0118593 A1
(43) Pub. Date: May 24, 2007

(54) Positioning system and method for LED display

(75) Inventors: Martin J. McCaslin, Pleasanton, CA (US); Shiraz M. Shivji, Saratoga, CA (US)

Correspondence Address: HEIMLICH LAW, 5952 DIAL WAY, SAN JOSE, CA, 95129, US

(73) Assignee: Shiraz M. Shivji, Saratoga, CA (US)

(21) Appl. No.: 11/189,168

(22) Filed: Jul. 25, 2005

Related U.S. Application Data
(60) Provisional application No. 60/591,110, filed on Jul. 26, 2004.

(51) Int. Cl. G06F 15/16

(52) U.S. Cl. 709/203

(57) ABSTRACT

A positioning system and method for a light emitting devices display have been disclosed.

### RELATED APPLICATION

This patent application claims priority of U.S. Provisional Application Ser. No. 60/591110 filed Jul. 26, 2004 titled “Positioning System and Method for LED Display”, which is by the same inventors as this application and which is hereby incorporated herein by reference. This patent application is related to U.S. application Ser. No. 10/810300 filed Mar. 26, 2004 titled “Method and Apparatus for Light Emitting Devices Based Display”, which has one common inventor with this application.

### FIELD OF THE INVENTION

The present invention pertains to displays. More particularly, the present invention relates to a positioning system and method for a light emitting devices (LED) display.

### BACKGROUND OF THE INVENTION

Many electronic displays have scanning mechanisms that allow them to display a picture by building up a picture pixel by pixel and line by line. For example, the cathode ray tube (CRT) which is an integral part of many televisions, video terminals, computer displays, and projection displays uses such an approach. Such CRT displays have one or more electronic guns from which electrons are accelerated towards a faceplate that has red, green, and blue phosphors that light up when struck by electrons. The electron beams are deflected by high voltages and/or by magnetic means and are usually scanned from left to right and from up to down to create a picture between 30 to 100 times a second. The observer sees a solid image due to the persistence of vision properties of the human eye. CRTs are bulky and require large amounts of power. This may present a problem.

Another approach to creating a display pixel by pixel and line by line is to use a deflected light beam. Light particles or photons have no electronic charge and hence electrostatic or magnetic means cannot be used for deflecting a light beam. However, scanning displays can be created using lasers and other light sources and using rotating mirrors to deflect the light beams. Rotating a mirror may present a problem.

### BRIEF DESCRIPTION OF THE DRAWINGS

The invention is illustrated by way of example and not limitation in the figures of the accompanying drawings in which:

FIG. 1 illustrates a network environment in which the present invention may be implemented;

FIG. 2 is a block diagram of a computer system which may be used for implementing some embodiments of the invention;

FIG. 3 illustrates one embodiment of the invention in block diagram form;

FIG. 4 illustrates one embodiment of the invention showing details of a substrate of an LED display;

FIG. 5 illustrates one embodiment of the present invention showing a two rail guide technique;

FIG. 6 illustrates one embodiment of the present invention showing a flexure-type guide technique;

FIG. 7 illustrates one embodiment of the present invention showing a double parallelogram flexure-type guide technique;

FIG. 8 and FIG. 9 illustrate embodiments of the invention showing a voice coil drive technique;

FIG. 10 illustrates one embodiment of the present invention showing a voice coil motor located beneath the payload and between the flexures;

FIG. 11 illustrates one embodiment of the present invention showing a voice coil motor located in line with the transport of the payload;

FIG. 12 illustrates one embodiment of the present invention showing a transport, base, and a substrate;

FIG. 13 illustrates one embodiment of the invention showing details of a sinusoidal scan;

FIG. 14 illustrates one embodiment of the invention showing details of a displacement of a flexure system;

FIG. 15 illustrates one embodiment of the invention showing details of position and force for displacement of a flexure system; and

FIG. 16, FIG. 17, and FIG. 18 illustrate calculations and graphs for embodiments of the invention.

### DETAILED DESCRIPTION

As used in this description, “LED” or similar terms refers to light emitting devices. There are a variety of light emitting devices, for example, light emitting diodes (commonly referred to as LEDs), visible light emitting lasers, vertical cavity surface emitting lasers (VCSELs), quantum dots, resonant cavity light emitting diodes (RCLEDs), organic light emitting diodes (OLEDs), electroluminescent diodes (ELDs), photon recycling semiconductor light emitting diode, etc. For convenience in illustrating various embodiments of the invention, LED and similar terms will refer to all such Light Emitting Devices, not to just light emitting diodes. That is, our use of LED here includes, light emitting diodes, lasers, etc. Where a distinction is made the text will explicitly use a specific term intended.

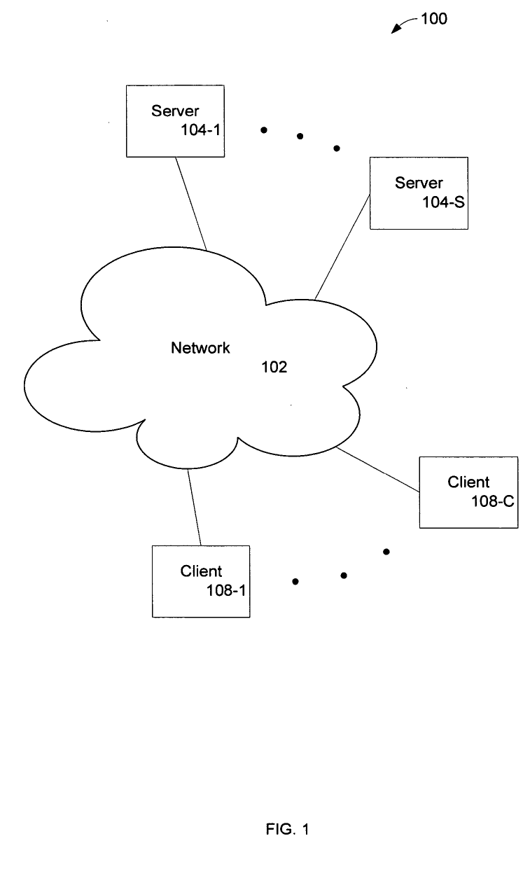

FIG. 1 illustrates a network environment 100 in which the techniques described may be applied. More details are described below.

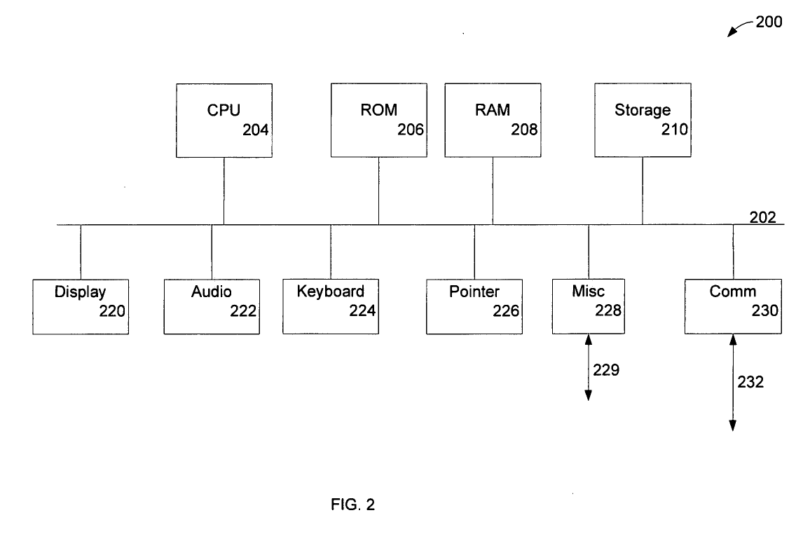

FIG. 2 illustrates a computer system 200 in block diagram form, which may be representative of any of the devices shown in FIG. 1. More details are described below.

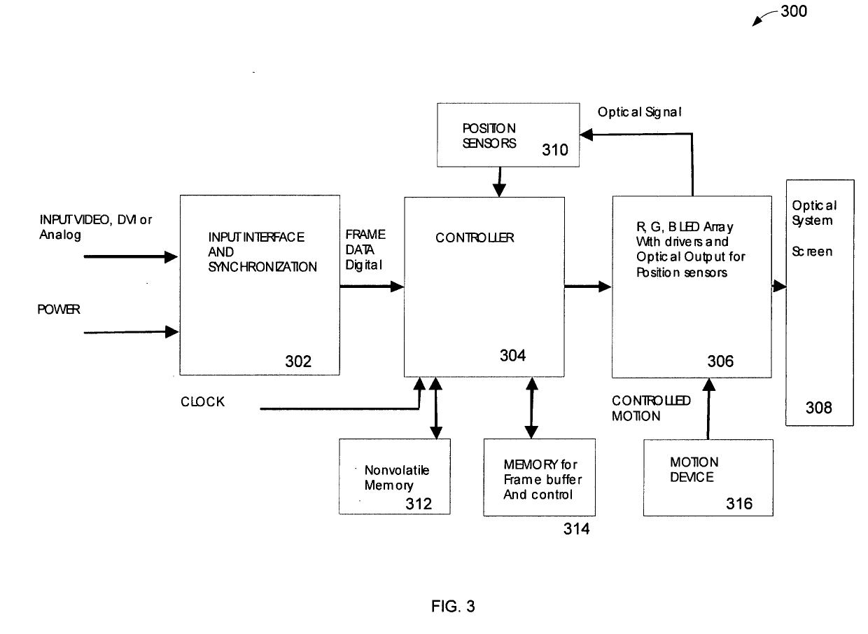

FIG. 3 illustrates one embodiment of the invention 300 in block diagram form. In this embodiment, a way to create a scanned image is shown by physically moving 316 a light source consisting of a column or several columns of red, green, and blue pixels 306. The motion part 316 of the system 300 is covered in more detail below. In such a system 300, deployed in a portable device it is important to minimize the power used in moving the light sources 306. Additionally, the design may benefit if the motion of the light sources 306 is precise and is consistent for every cycle. In this embodiment a position feedback mechanism 310 is utilized. For portable applications, the size and weight of the mechanics should be minimized as well to allow operation with less power. Finally, the motion device should be durable and be capable of operating for billions of cycles.

At 302 is in input interface and synchronization block which inputs power and an input video signal, such as, analog, DVI, etc. Block 302 outputs a frame data signal that goes into controller 304. Controller 304 receives as input a clock and position sensor (from 310) information. Controller 304 is in bidirectional communication with non-volatile memory 312, and memory for a frame buffer and control 314. Controller 304 outputs control data which goes to the LED array 306. LED array 306 also receives controlled motion from motion device 316. The LED array outputs an optical signal which goes to the position sensors 310 and an optical output which goes to the optical system screen 308.

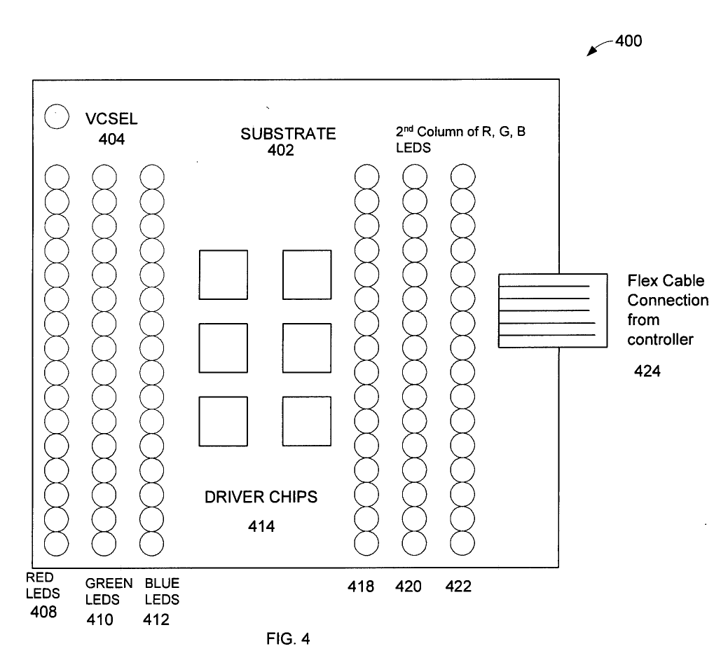

FIG. 4 illustrates one embodiment 400 of the invention showing more details of a substrate 402. The substrate 402 has mounted on it: a VCSEL 404; a first array of LEDs column 408 of Red LEDs, column 410 of Green LEDs, and column 412 of Blue LEDs; a second array of LEDs column 418 of Red LEDs, column 420 of Green LEDs, and column 422 of Blue LEDs; six driver chips 414 for driving the first (408, 410, 412) and second (418, 420, 422) of LEDs; and a connection 424 from components on the substrate 402 to a controller (such as 304 in FIG. 3).

This discussion will now detail several embodiments of the invention for guiding and driving an LED array as illustrated in one embodiment of the invention 400 in FIG. 4. Linear motion is explained as this is most easily understood. Additionally, for a more precise explanation, guidance systems and drive systems will be described separately. One of skill in the art will recognize that any such combination of guidance and drive system may be used in various embodiments of the present invention.

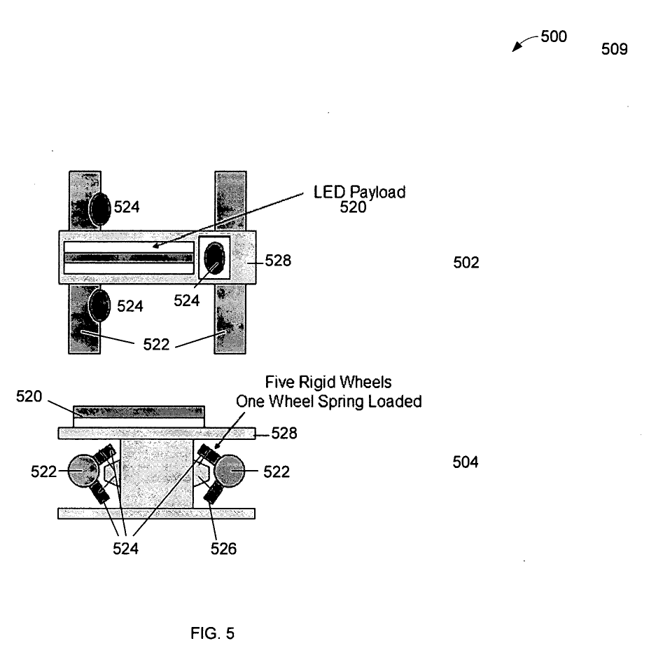

FIG. 5 illustrates one embodiment 500 of the present invention showing a two rail guide technique. In this guidance technique, one or two circular rails guide a payload mass having either bushings, linear bearings, ball bearing wheels, etc. One or more wheels may have a spring to pre-load the system. In one embodiment of the invention, an angled way (such as a 45 degree way) may be machined to serve the same function as the rails. By proper manufacturing friction may be reduced and wear effects minimized. This embodiment has no restoring force in the line of action for these systems, so the payload is stable at any position within the designed stroke. At 502 is shown a top view with the LED Payload (the LED devices, drivers, etc.) 520. Also shown are two guide rails 522, and the top of 3 guide wheels 524, and the substrate 528. At 504 is a side view of that shown at 502. Here at 504 may be seen the LED payload 520, the guide rails 522, the rigid wheels 524, one wheel being spring loaded 526, and the substrate 528.

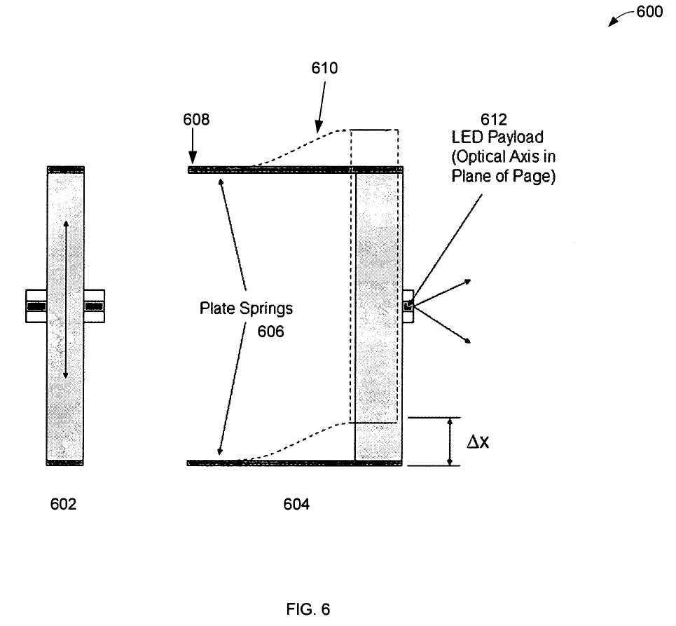

FIG. 6 illustrates one embodiment 600 of the present invention showing a single parallelogram flexure-type guide technique. A flexure-type system may employ a pair of flat (plate) springs 606. In this embodiment, frictional and wear effects are substantially eliminated because there is no relative motion between stationary (for example at 608) and moving parts (for example at 610). A restoring force exists for these systems, so the payload 612 is stable in the center (neutral) position, and a bias force is needed to deflect the payload. Pure linear motion does not result (as will be detailed later) from a single pair of parallelogram plate springs (such as 606). As will be explained later, a flexure-type system exhibits a fundamental (natural) frequency where displacement amplification at resonance may be utilized to advantage. At 602 is a back view of the flexure-type guide. At 604 is a side view of the flexure-type guide showing the plate springs 606, the LED payload 612, and the flexure as denoted by dashed lines (for example at 610).

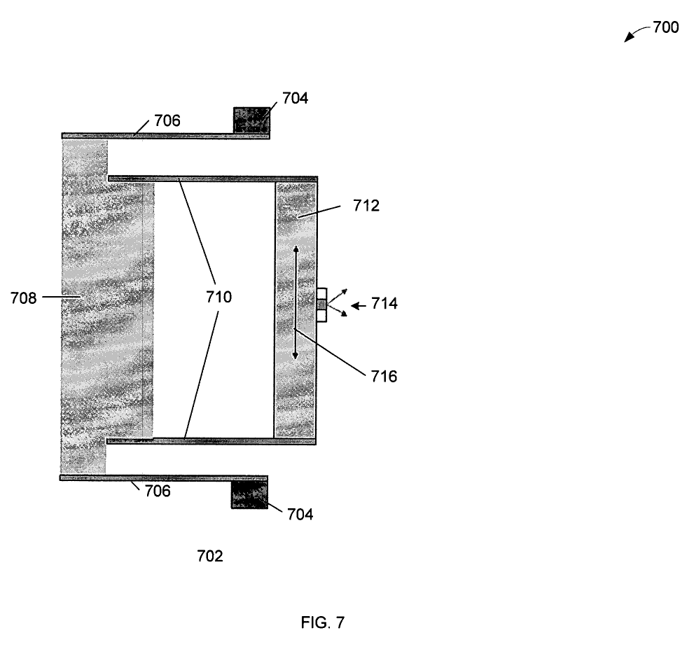

To provide for pure linear motion using a flexure-type guide, a second pair of “arms” may be employed as shown in FIG. 7 illustrating a double parallelogram flexure guidance. At 702 is a side view of the double parallelogram flexure guidance system. As explained later, a flexure-type system exhibits a fundamental (natural) frequency where displacement amplification at resonance may be utilized to advantage. At 704 is a first rigid structure to which a first set of plate springs 706are attached. The first set of plate arms 706 are then attached to a second rigid structure 708. Attached to the second rigid structure 708 is a second set of plate springs 710 which are also attached to a third rigid structure 712 which may be a substrate. At 714 on the substrate is an LED payload with the optical axis in the plane of the page for FIG. 7. The arrow at 716 indicates the direction of travel for 712.

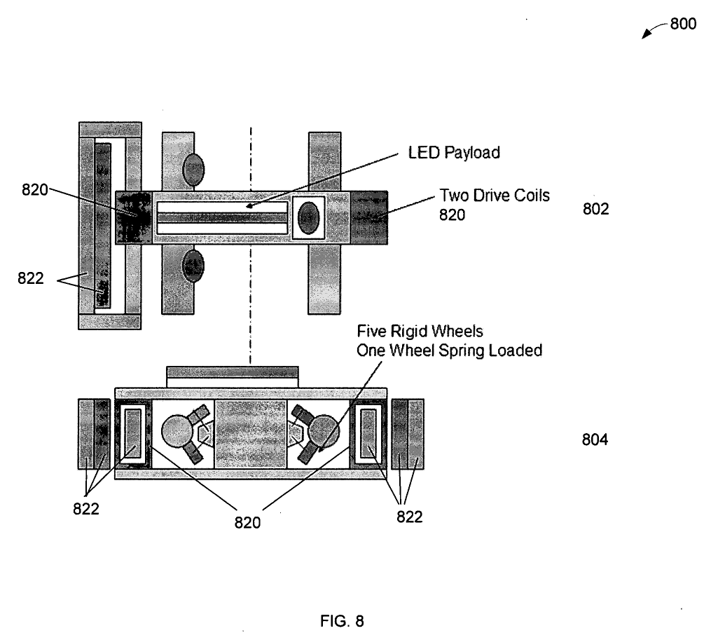

FIG. 8 illustrates one embodiment 800 of the invention showing a voice coil drive technique as applied to a two rail guidance system (such as that illustrated in FIG. 5). At 802 is a top view of a drive system using two drive coils 820. For clarity of illustration at 802 the leftmost associated magnetic structure 822 is only shown. At 804 is a side view of 802 showing the two drive coils 820 and the associated magnetic structures 822 (as seen in the leftmost part of 802). One of skill in the art will appreciate that the voice coil motor drive technique may be used for both linear and rotary motion requirements. Additionally, because the drive is non-contact it has less wear.

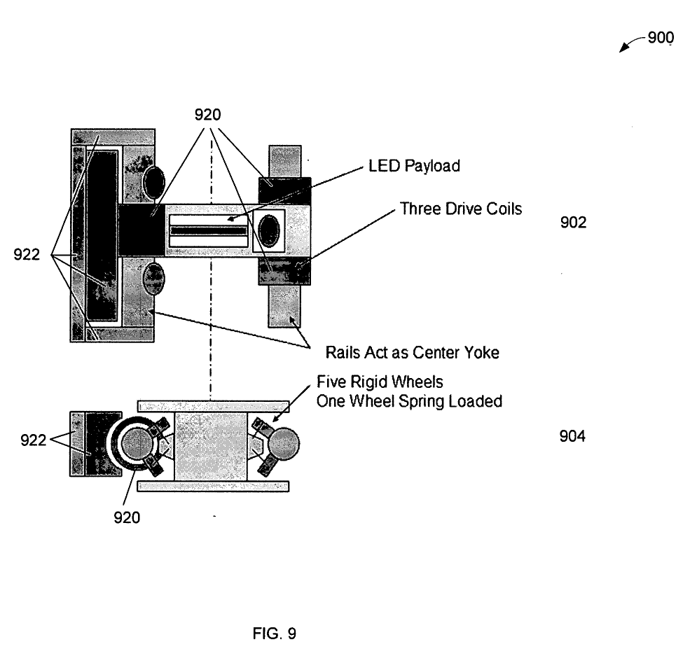

FIG. 9 illustrates one embodiment 900 of the invention showing a voice coil drive technique as applied to a two rail guidance system (such as that illustrated in FIG. 5). At 902 is a top view of a drive system using three drive coils 920. For clarity of illustration at 902 the rightmost magnetics associated with two drive coils are not shown, but are shown for the leftmost drive coil at 922. At 904 is a side view of 902 showing only the leftmost drive coil 920 and the associated magnetic structures 922 (as seen in the leftmost part of 902). Here the rails may act as the center yoke in a linear motor. One of skill in the art will appreciate that the voice coil motor drive technique may be used for both linear and rotary motion requirements and may utilize one or more drive coils as may be appropriate. Additionally, because the drive coil is not in contact with the magnetics there is less wear than a system having mechanical contact.

Additional drive techniques may use motors of other structures, for example, but not limited to, stepper motors, piezoelectric drive motors, electro-static motors, etc.

Stepper motor drives may be used to drive a LED payload. For example, by coupling a stepper motor to a drive element, such as a lead screw, which is connected to the payload stage, the LEDs may be moved. Because of the lead screw there may be friction and wear in the mechanical design.

A piezoelectric drive may be used where small precise movements are needed for positioning as may an electrostatic type drive.

A detailed discussion of one embodiment of the invention using a flexure-type/voice coil motor (VCM) system follows.

In the present invention, a flexure-type/VCM system is disclosed that takes advantage of natural frequency amplification or resonance of a flexure to lower driving energy. An assumed percent damping of 0.5% and 0.9%, for example, would result in amplifications of 100× and 56× respectively. Driving the mechanism at resonance may not require a full duty cycle, so a sinusoidal or pulse wave input can be considered. The resulting power and space savings may be substantial.

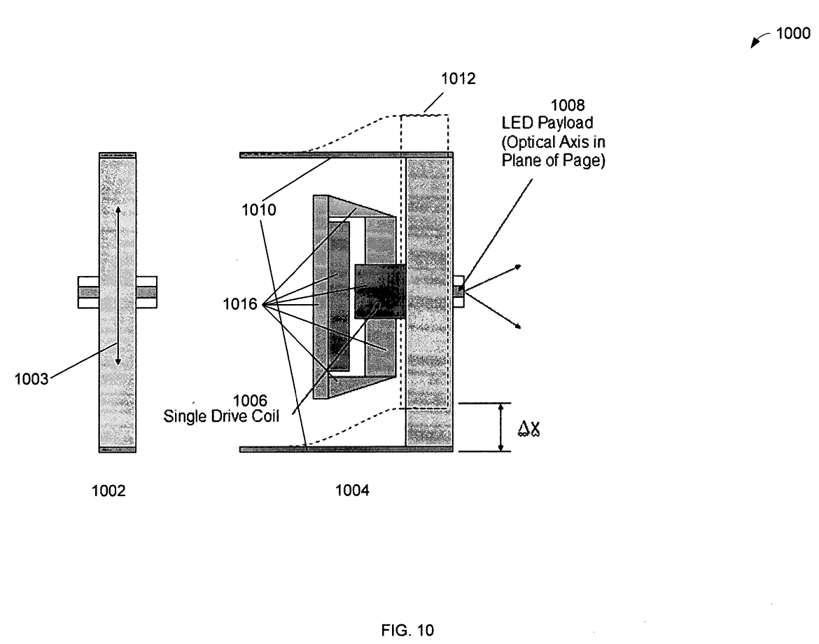

FIG. 10 illustrates one embodiment 1000 of the present invention showing a voice coil motor 1016 having a single drive coil 1006 located beneath the payload 1008 and between the flexures 1010. At 1002 is shown a bottom view indicating the direction of motion of the LED payload and stage 1003 (voice coil not shown for clarity). At 1004 is a side view showing a single voice drive coil 1006 and flexing as illustrated by the dashed lines 1012. The LED payload is also illustrated 1008.

One of skill in the art will appreciate that the natural frequency of the system may be designed to match the scan requirements for an LED display. For example, if a 60 Hz refresh rate is desired, a fundamental system resonance of 30 Hz will translate the LED payload appropriately. (At 30 Hz the LED payload will cross the screen “forward” and “backward” 30 times a second. Because the LED payload may illuminate the scan on both the forward and backward motion, this results in a 60 Hz refresh rate.)

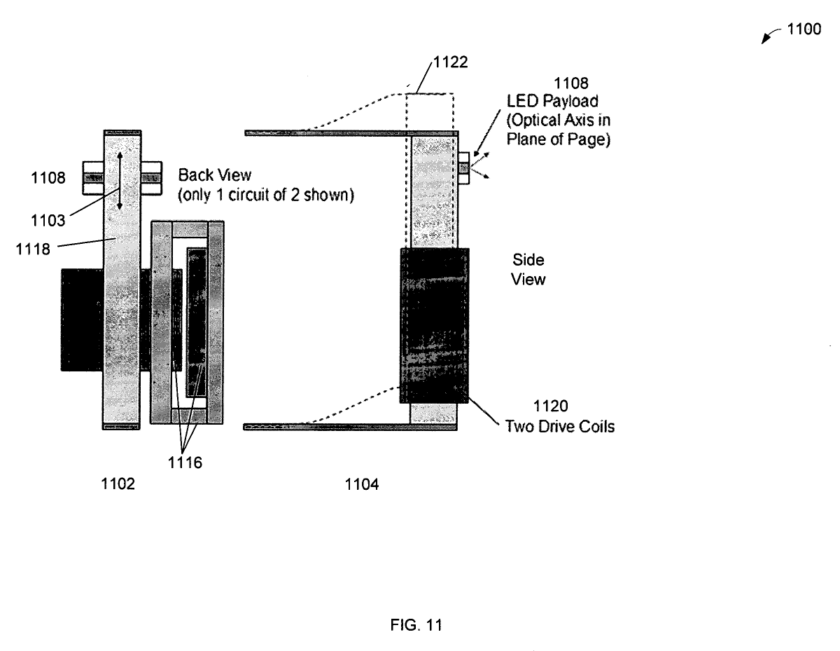

FIG. 11 illustrates one embodiment 1100 of the present invention showing a voice coil motor 1116 located in line with the transport of the payload 1108. At 1102 is shown a bottom view indicating the direction of motion 1103 of the LED payload 1108 and stage 1118 (only one voice coil shown for clarity). At 1104 is a side view showing two voice drive coils 1120 and flexing as illustrated by the dashed lines 1122. The LED payload is also illustrated 1108.

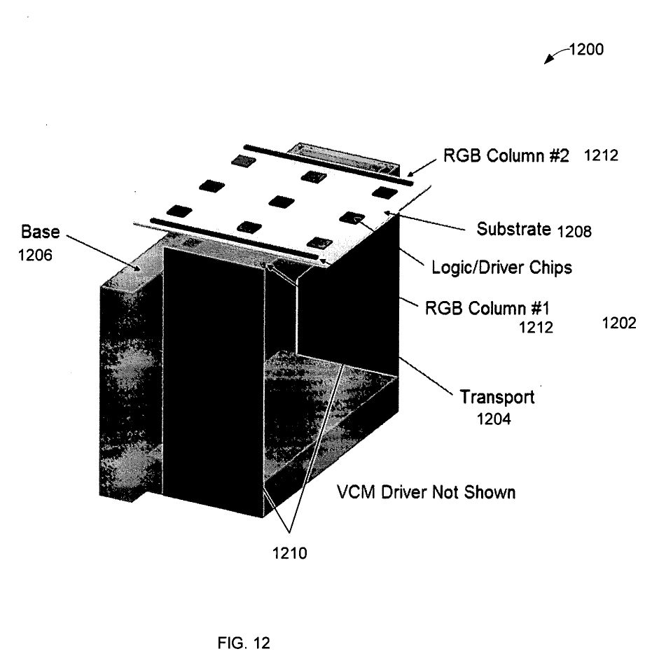

FIG. 12 illustrates one embodiment 1200 of the present invention showing a transport 1204, base 1206, and a substrate 1208. As may be seen, a base 1206 provides support for the flexures 1210 which are connected to the transport 1204 on which is mounted the LED payload 1212. The LED payload 1212 in this embodiment is a substrate 1208 having two rows of RGB emitters, logic, and driver chips. Not shown, for sake of clarity is the VCM.

In such a flexure-type NCM system with LED payload 1212 is shown in FIG. 11, the mechanical amplification is approximately 40 dB (or 100 times) that which would result from a non-resonant mechanical system. The non-linear motion resulting from the single pair of parallelogram plate springs 1210 may be accommodated by optical correction and/or timing of the energizing of the LEDs in the LED payload 1212.

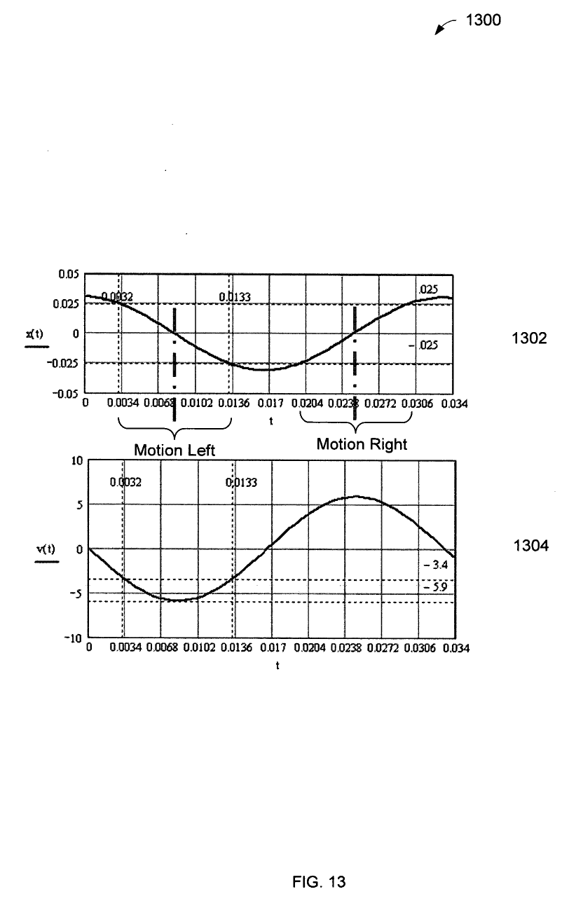

FIG. 13 illustrates one embodiment 1300 of the invention showing details of a sinusoidal scan. The flexure system, as shown in FIG. 12, creates sinusoidal motion as shown in FIG. 13. It is possible to create an image accurately by changing the time for which a particular pixel column is energized. The LEDs are energized during part of the motion to the right and to the left as shown here in FIG. 13. At 1302 is shown the motion x(t) with respect to time t. At 1304 is shown the velocity v(t) with respect to time t.

A detailed explanation of the operation in such a mode will now be given.

If dᵢ is the distance traveled to create pixels for the ith column, then to create equal size pixels,
dᵢ=d, a constant.
dᵢ=∫vdt (Equation 1)
where the upper limit of the integral is ti and the lower limit is tᵢ₋₁
and dᵢ=distance traveled to create the ith column
tᵢ=time when the energization of the ith column ends
tᵢ₋₁=time when the energization of the (i−1)th column ends.
The distance x(t) is given by:
x(t)=a cos(ωt). (Equation 2)
The velocity v(t) is given by:

$$\begin{matrix}v ( t ) = \frac{ⅆ x}{ⅆ t} \\ = - a ω sin ( ω t ) .\end{matrix} \qquad ( Equation 3 )$$

In one embodiment of the invention, assume that at time zero, the substrate is to the right i.e. x(0)=a, and the velocity is zero i.e. v(0)=0. The substrate starts moving to the left, in a negative direction, until it reaches the extreme leftmost end. The LEDs get energized starting from t=0.00034 seconds as shown in FIG. 13. The energization (causing the LED(s) to emit light or not emit light) is in accordance to the column of the picture to be displayed and for the duration based on that position. The energization stops after column 1 (the leftmost column) is reached at t=0.0136 seconds. At that point the velocity is zero. The substrate starts moving to the right and goes past the zero position and to the right until it reaches the extreme right position.

Some applicable numbers are as follows:
ω=2πf where f is the frequency in cycles per second.
ω=2π30 (Equation 4)

In this embodiment, use is made of that portion of the motion where the velocity (positive and negative) is not zero. It will be that the region where ωt=2π35/360 to 2π145/360 for the motion to the left and ωt=2π215/360 to 2π325/360 for the motion to the right side which are reasonable choices.

From the equations above it is possible for the controller to know the values of tᵢ and tᵢ₋₁ since all the other quantities are known. The product of time and velocity is constant, so to have the same apparent size column width, when the velocity is the highest the time interval for the column is the shortest. Conversely, if the velocity is low, the time interval is large. However, the longer the time interval the brighter the column may appear to a viewer. Therefore, a correction that depends on the column position may be applied. FIG. 13 shows that the velocity is highest at the center column of the image. This implies that the center will be apparently less bright than the right and left extremes of the image. A correction factor can be applied to the excitation values for the LEDs to correct for this.

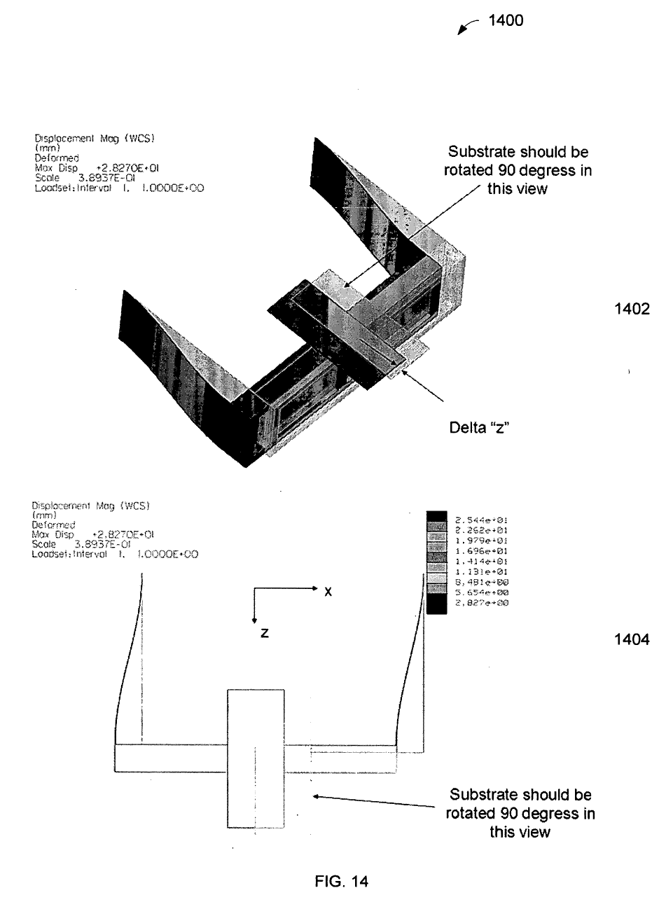

FIG. 14 illustrates one embodiment 1400 of the invention showing details of a displacement of a flexure system. At 1402 is shown a three dimensional view. At 1404 is shown an x-z plane view.

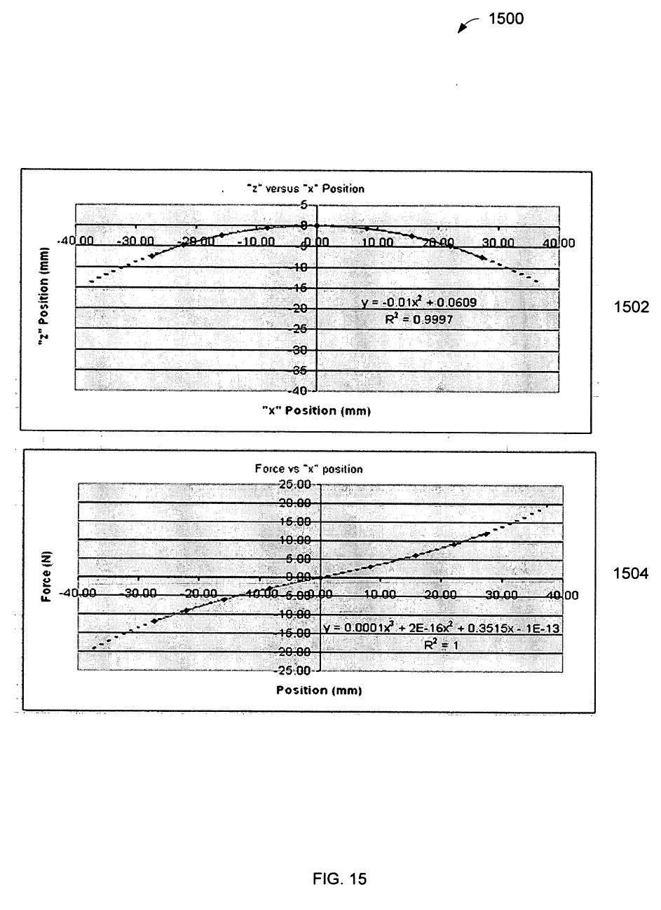

FIG. 15 illustrates one embodiment 1500 of the invention showing details of position and force for displacement of a flexure system. This illustrates the non-linear behavior of a single parallelogram flexure guidance type system. At 1502 is shown z versus x position. At 1504 is shown force versus x position.

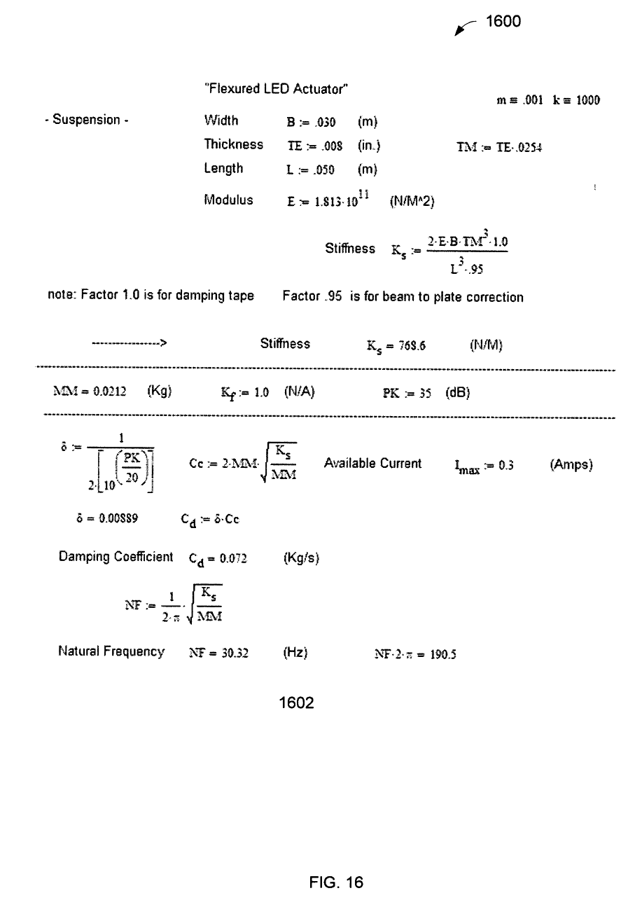

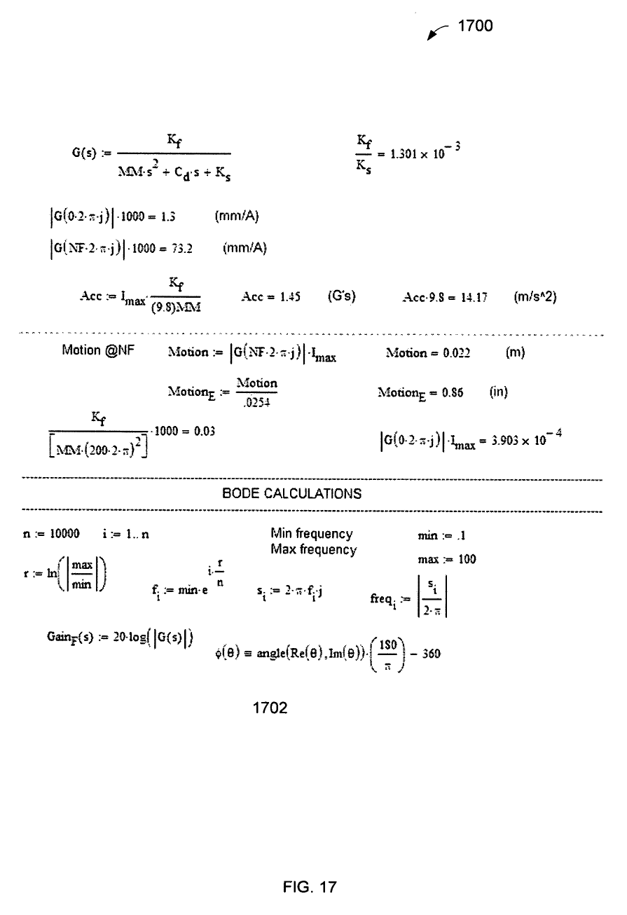

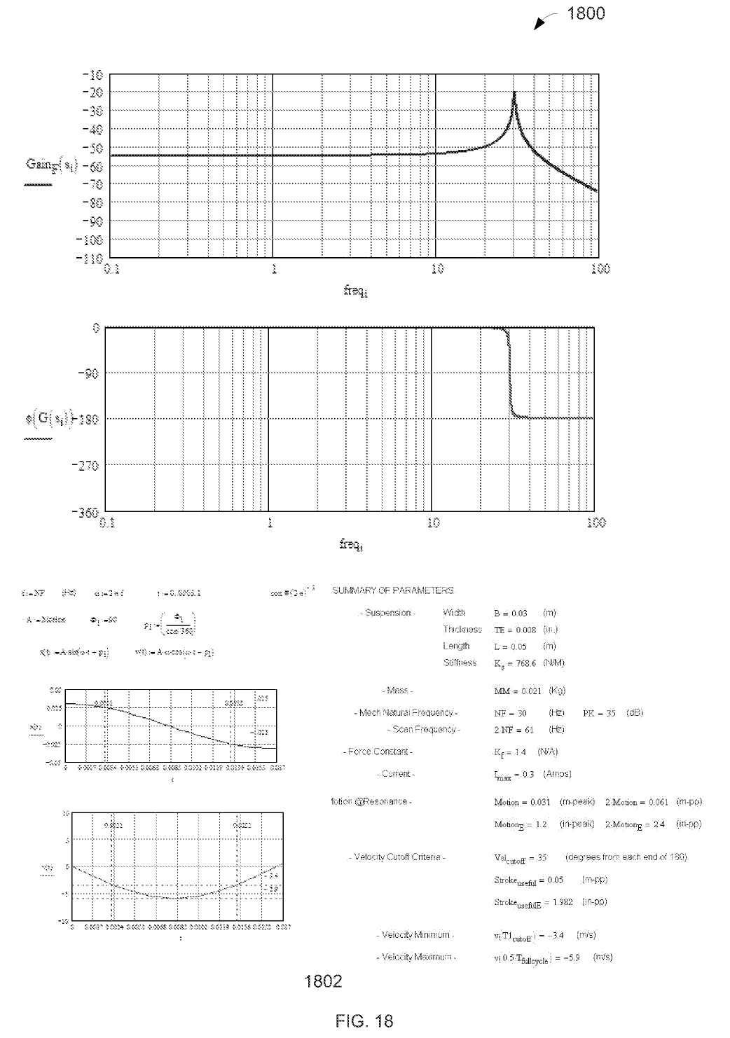

FIG. 16 illustrates calculations 1600 for one embodiment 1602 of the invention.

FIG. 17 illustrates calculations 1700 for one embodiment 1702 of the invention.

FIG. 18 illustrates graphs and calculations 1800 for one embodiment 1802 of the invention. As illustrated the computations illustrate an embodiment of the invention supporting a 30 Hz system.

One of skill in the art will appreciate that the present invention is not limited to a 30 Hz system and that any frequency can be chosen, and still be within the scope of this invention. Furthermore, other drive and guidance means, as described above, are also within the scope of the present invention.

Thus a positioning system and method for an LED display have been described.

FIG. 1 illustrates a network environment 100 in which the techniques described may be applied. The network environment 100 has a network 102 that connects S servers 104-1 through 104-S, and C clients 108-1 through 108-C. More details are described below.

FIG. 2 illustrates a computer system 200 in block diagram form, which may be representative of any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of visual communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220 (for example, embodiments of the present invention), audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a light emitting diodes based display have been described.

What is claimed is:

1. An apparatus comprising:
a substrate having a plurality of columns of light emitting diodes (LEDs) mounted on said substrate;
a position sensor in communication with said substrate for determining position of said substrate;
a movable structure in communication with said substrate; and
a moving mechanism for moving said movable structure.

2. The apparatus of claim 1 further comprising a driver for driving zero or more LEDs in said columns of LEDs based upon said position.

3. The apparatus of claim 2 wherein said movable structure is a flexing type structure and said moving mechanism for moving said movable structure is a flexing mechanism for flexing said flexing type structure.

4. The apparatus of claim 3 wherein said flexing type structure is a 2 plate spring type structure.

5. The apparatus of claim 3 wherein said flexing type structure is a double parallelogram flexure-type structure.

6. The apparatus of claim 5 wherein said columns of LEDs are oriented to emit light substantially normal to the plane of flexing.

7. The apparatus of claim 5 wherein said columns of LEDs are oriented to emit light substantially at right angle to the plane of flexing

8. The apparatus of claim 5 wherein said position sensor is in communication with one or more LEDs in said columns of LEDs.

9. The apparatus of claim 1 wherein said movable structure is a rail type linear motion device having one or more rails and said moving mechanism is one or more voice coils.

10. A method comprising:
receiving display information;
sensing a position of a substrate having a plurality of columns of light emitting diodes (LEDs) mounted on said substrate;
moving said substrate; and
driving zero or more LEDs in said plurality of columns of LEDs based on said position of said substrate, said velocity of said substrate, and said received display information.

11. The method of claim 10 wherein said moving further comprises flexing a flexible structure.

12. The method of claim 11 wherein said flexing further comprises flexing said flexible structure at said flexible structure's resonant frequency.

13. The method of claim 10 wherein said moving said substrate is based on said position.

14. An apparatus comprising:
means for receiving display information;
means for sensing a position of a substrate having a plurality of columns of light emitting diodes (LEDs) mounted on said substrate;
means for moving said substrate; and
means for driving zero or more LEDs in said plurality of columns of LEDs based on said position of said substrate, said velocity of said substrate, and said received display information.

15. The apparatus of claim 14 wherein said means for moving further comprises means for flexing a flexible structure.

16. The apparatus of claim 15 wherein means for flexing a flexible structure further comprises means for flexing said flexible structure at said flexible structure's resonant frequency.

17. The apparatus of claim 15 wherein said means for flexing is based on said position.

18. The apparatus of claim 14 wherein said means for moving said substrate is means for moving said substrate on a linear rail means using voice coil means.

19. The apparatus of claim 14 wherein said means for moving said substrate is means for moving said substrate on a flexure type structure means using voice coil means.

20. The apparatus of claim 14 wherein said means for moving said substrate is means for flexing a double parallelogram flexure-type structure at substantially said double parallelogram flexure-type structure's natural resonance.
